(19) United States
(12) Patent Application Publication
(10) Pub. No.: US 2016/0063264 A1
(43) Pub. Date: Mar. 3, 2016

(54) METHOD FOR SECURING A PLURALITY OF CONTENTS IN MOBILE ENVIRONMENT, AND A SECURITY FILE USING THE SAME

(71) Applicant: KINGS INFORMATION & NETWORK, Hanam-si (KR)

(72) Inventor: Jong Kyung BAEK, Hanam-si (KR)

(21) Appl. No.: 14/472,375

(22) Filed: Aug. 29, 2014

(51) Int. Cl. G06F 21/62; G06F 21/60; G06F 17/30

(52) U.S. Cl. CPC G06F 21/6209; G06F 17/3012; G06F 21/602

(57) ABSTRACT

There is provided a method for protecting a plurality of contents in mobile terminal, the method includes; storing a header portion for storing file names and folder structure of the plurality of contents; and a body portion for storing file binary values of the plurality of contents, when the plurality of contents are stored; wherein the file binary values of the plurality of contents is partially encrypted.

### FIELD OF THE INVENTION

The present invention relates to a method for securing a plurality of contents in mobile environment.

### BACKGROUND OF THE INVENTION

In recent, with the development of information-oriented society, cloud services using a high-speed data transfer and large capacity storage have been actively ongoing. The cloud service refers to an environment that enables the distributed processing of a large capacity database in the virtual space of the Internet with the help of a web-based application and various terminals such as desktop PCs, mobile phones, notebook PCs, etc. to fetch or process the data.

Thus, in the cloud computing environment, a service provider integrates servers (in the data centers) that are distributed to multiple locations with virtualization technology to provide services that users need.

In this case, the user selects guest machines to be used on a virtual space through the virtualization technique (a guest machine means a conceptual logical equipment on the virtual space and may be understood as a kind of virtual machines including an operating system, security and the like) as much as needed at any point in time, instead of directly installing the necessary resources such as an OS (Operating system), Storage, application, security, etc. in his/her own terminal. Therefore, the user does not pay purchasing cost for the computing resources based on the amount of the use, which leads to economic benefits.

In addition, the user has benefits that can perform a task that requires a large-capacity storage device and a high-performance computing resource by connecting to the cloud network through a terminal having a capability of network connection and performing arithmetic functions and receives advanced services in any place.

However, in the cloud computing environment, because of issues of security threats such as external hacking attacks, security issue that can protect the assets from the threats has emerged as the most important challenge. Existing cloud security system merely relies on security equipment provided from the service provider and collect and manage security events that occur segmentally fragmentarily.

On the other hand, business users are downloading contents related to business via smart devices or doing their modification works. However, such downloaded contents are sometimes stored uncoded or shared externally. For this reason, such contents are vulnerable to information security.

### SUMMARY OF THE INVENTION

In view of the above, the present invention provides a management methods for a file control, security and others that are performed in a client terminal such as a mobile phone, notebook PC, PDA connected to a cloud server in a cloud computer environment.

The client terminal may include any equipment having a networking capability such as a PC, notebook, mobile terminal, etc. Preferably, the client terminal may be a mobile terminal and may be a smear phone among others. The smartphone refers to a system in which the operating system such as Android OS, or the like is installed in a mobile cellular phone. The application of the embodiment to the mobile terminal enables that the user downloads necessary files only without downloading of information in a user folder in the cloud server in a lump. The downloaded files are then encrypted and kept in the mobile terminal, thereby maintaining a security of the files.

In accordance with an aspect of the invention, there is provided a security file for a plurality of contents, the security file includes; a header portion for storing file names and folder structure of the plurality of contents; and a body portion for storing file binary values of the plurality of contents; wherein the file binary values of the plurality of contents is partially encrypted.

‘content’ is various data which is not specified, includes documents, moving pictures, audio data, pictures, and so on.

Preferably, the respective of the file binary values of the plurality of contents includes beginning, middle, and end.

Preferably, the file binary values of the plurality of contents is shuffled with each other.

In accordance with another aspect of the invention, there is provided a method for protecting a plurality of contents in mobile terminal, the method includes; storing a header portion for storing file names and folder structure of the plurality of contents; and a body portion for storing file binary values of the plurality of contents, when the plurality of contents are stored; wherein the file binary values of the plurality of contents is partially encrypted.

In accordance with the other aspect of the invention, there is provided a computer readable medium for the method.

### BRIEF DESCRIPTION OF THE DRAWINGS

The above and other objects and features of the present invention will become apparent from the following description of the embodiments given in conjunction with the accompanying drawings, in which:

FIG. 1 is a schematic configuration diagram of an overall cloud computing system to which the embodiment of the present invention;

FIG. 2 is a block diagram of the mobile application 1100 that is installed in a mobile terminal in a cloud computing system in accordance with an embodiment of the present invention;

FIG. 3 is a flow chart illustrating a process of installing the mobile application 1100 shown in FIG. 2 in the mobile terminal;

FIG. 4 depicts a view illustrating the structure of the security file in accordance with an embodiment of the present invention;

FIG. 5 is a flow chart showing a method of partially encrypting the security file according to the invention.

FIG. 6 is a flow chart illustrating a process of performing a file read operation using the mobile application 1100 shown in FIG. 2.

### DETAILED DESCRIPTION OF THE EMBODIMENTS

Hereinafter, the embodiments of the present invention will be described in detail with reference to the accompanying drawings. However, the embodiments of the present invention as illustrated below may be modified in various different forms, and the scope of the present invention is not intended to the limit the embodiments as set forth above. It should be noted that the embodiments are provided to make a full disclosure and also to allow those skilled in the art to know the full scope of the present invention.

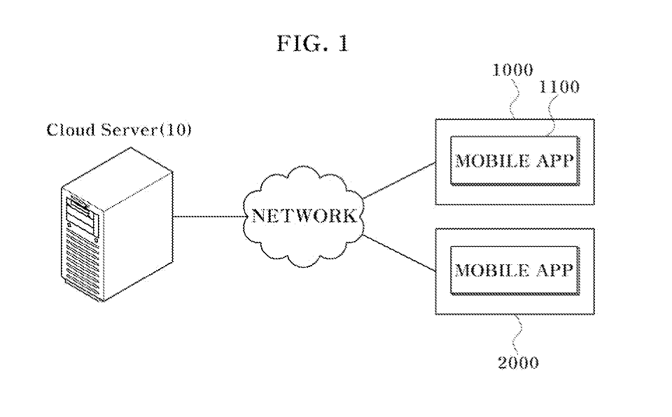

FIG. 1 is a schematic configuration diagram of an overall cloud computing system to which the embodiment of the present invention.

Referring to FIG. 1, a cloud computing system includes a plurality of client terminals 1000, 2000 and a cloud server 10 that are connected via a network.

The client terminals 1000 and 2000 are entitles utilizing resources of the cloud server 10 on the network in a cloud computing environment. Specifically, a client terminal refers to equipment having a networking capability, which is a terminal that is used by the user, e.g., a PC, a notebook, a mobile terminal, and others. FIG. 1 shows that the client terminal represented by a reference numeral 1000, 200 is a mobile terminal and includes a mobile cloud application 1100. However, it will be understood that the mobile cloud application 1100 is classified for a convenience and detailed functions of the application may be exchanged with other terminal such as PCs.

The cloud server 10 is a physical equipment that has a connection with plurality of the client terminals 1000, 2000 and provides system resources (which includes, e.g., OS, CPU, memories, storage devices). In a cloud computing environment, it is noted that a plurality of servers is connected with the plurality of the client terminals 1000 and 2000, and one of them, e.g., the cloud server 10 represents a concept to embrace the plurality of the servers.

For example, a guest machine that is created in a virtual space allocates the system resources to the client terminals 1000 and 2000 so that they utilize the system sources allocated to them. The foregoing matters may be understood as known general concepts in the art.

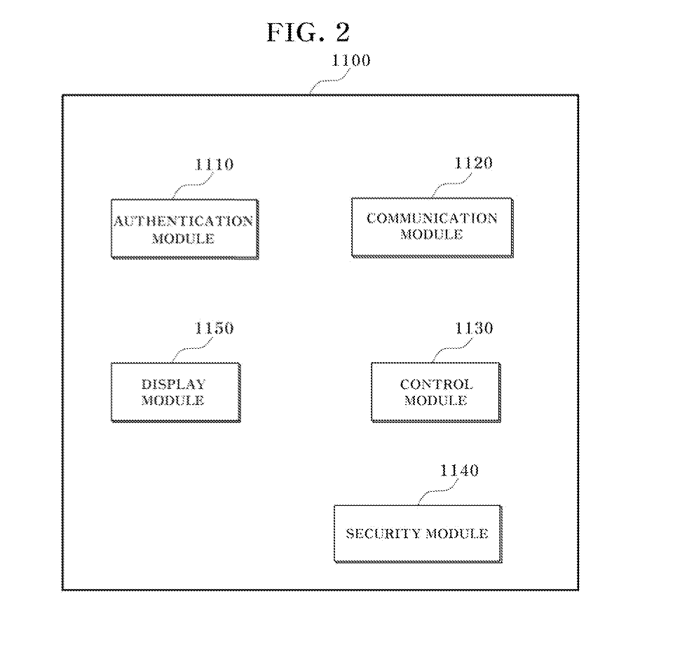

FIG. 2 is a block diagram of the mobile application 1100 that is installed in a mobile terminal in a cloud computing system in accordance with an embodiment of the present invention.

Referring to FIG. 2, the mobile application 1100 includes an authentication module 1110, a communication module 1120, a control module 1130, a security module 1140, and a display module 1150. The communication module 1120 communicates with cloud server 10.

The control module 1130 functions as a main part of the mobile application 1000 for performing various functions. For example, if the mobile application is implemented as a type of email application, the control module 1130 carries out a transmitting, receiving, editing, display, and so on. If the mobile application is implemented as a type of cloud service application in terminal, the control module 1130 carries out downloading data from the cloud server, saving the data, performing various editing, and so on.

The authentication module 1110 authenticates the user by communicating with the cloud server 10 when the user logs in.

The display module 1150 serves to provide a UI (User Interface) to the client terminal. For example, when the user clicks an execution icon to run the cloud application, a screen for login is displayed with the help of the display module 1150.

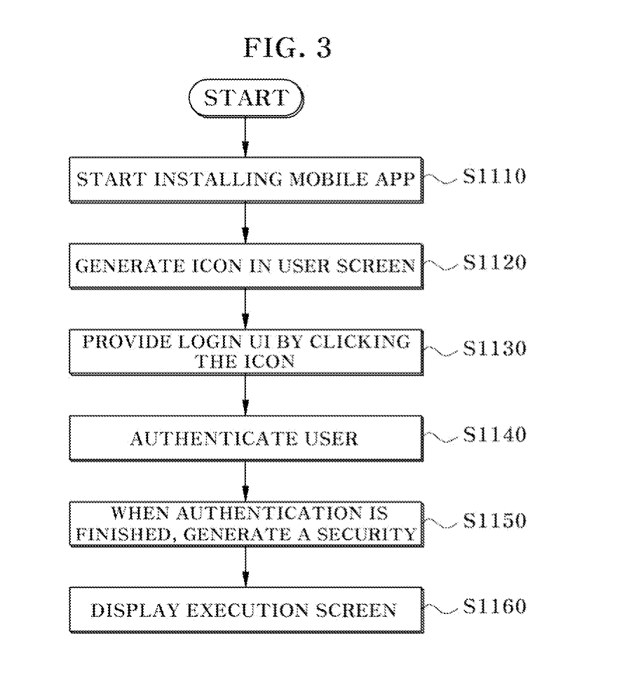

FIG. 3 is a flow chart illustrating a process of installing the mobile application 1100 shown in FIG. 2 in the mobile terminal.

The user downloads the mobile application for installing in the cloud terminal 1000 and initiates to install the mobile application (S1110). When the installation of the mobile application is completed, an icon is created on the client terminal 1000 (S1120). When the user clicks the icon to run the mobile application 1100, a screen for login is displayed (S1130). When the user logs in, the authentication module 1110 of the mobile application 1100 authenticates the user by communicating with the cloud server 10 through the communication module 1120 (S1140). After the completion of the user authentication, the mobile application 1100 creates a security file (S1150). Next, the mobile application 1100 provides an execution screen (S1160).

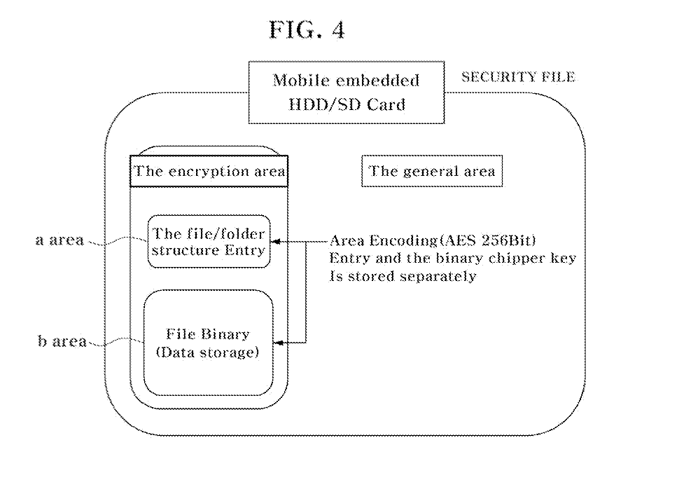

FIG. 4 depicts a view illustrating the structure of security file in accordance with an embodiment of the present invention.

Referring to FIG. 4, the security file includes a header portion and a body portion. The header portion (an area ‘a’) has an entry of file and folder structure and body portion (an area ‘b’) has a file binary value (Data). In this case, the header and the body areas of the security file are encrypted before being stored.

Detailed information in header portion includes meta data such as a file name, a logical structure path, location of binary, binary size before being encrypted, hash data after being encrypted, and the like.

The encryption may preferably be used with U.S. Federal standard algorithm, Advanced Encryption Standard (AES). But other different kinds of encryption algorithms which are not particularly specified may also be employed.

The creation of the security file according to the invention is for protecting data (contents) such as documents, moving pictures, and email information when they are downloaded and stored in the mobile terminal from the cloud server 10 or other means.

For example, if the mobile application is implemented as a type of email application, each email data are stored as contents of the security file. In this case, when the user wants to see email list, the mobile application shows the email list after decrypting the security file and reading out the header portion of the security file. When the user wants to open a content (for example, a document), the mobile application reads out the header portion of the security file and acquires the location of file binary data. Thereafter, the content can be opened by accessing the location.

The security file may be implemented in word process view application, image view application, image editor application, moving picture view application, moving picture editor, email application, and so on. As another type, the security file may be created and used independently. This means the security file is not inserted in specific application and separately created with the other applications. When other applications need the security file, for example an application need to get an image file in the security file, the security file can be used.

According to this way, there is an advantage in that the security file can be implemented without using windows virtual driver techniques of the Microsoft. The windows virtual driver is a driver used to perform an encryption and conversion of the security file to make it visible to the window EXPLORER.

In accordance with an embodiment, because the security files are read in a present format in a mobile OSs such as the Android, IOS, and the like, the virtual disk driver of the Microsoft may not be used. This enables to apply the structure of the security file and security capability to OS systems that do not use the virtual disk driver of Microsoft.

The encryption and decryption method according to the embodiment Korean patent application 2013-23961 (Application date, 2013. Mar. 6.) and 2013-48330 (2013. Apr. 30.) are incorporated in herewith.

According to the embodiment, a plurality of contents are stored in the security file. The file binary of the plurality of contents are stored in the body portion. In addition, the header portion (‘a’ area) and the body portion (‘b’ area) are encrypted with different independent keys. This makes the security file to have the higher security, because two key structure can protect hackers to duplicate key, compared to one key method. One key method means that the header portion (‘a’ area) and the body portion (‘b’ area) are encrypted with one key.

Two key method will be described in detail. PKI (Public Key Infrastructure) is well known method to protect the leakage of the key and information. This method exchanges keys with generated certificate (for example, public key certificate). ‘Key’ is a constant with which message and contents can be opened and closed. There have been a several researches that PKI method has weak points in security issue. Recently, Korean government is requesting the method without public key certificate. The embodiment can solve the problem issued by Korean government.

In mobile terminal (for example, mobile application), two prime numbers are generated using authentication information (ID, password, equipment unique value, MAC, telephone number, etc.). RSA key pairs of public key and private key are generated using the two prime numbers. Next, AES (Advanced Encryption Standard) private key 1 is generated using the generated public key and private key. As a alternative, AES (Advanced Encryption Standard) private key 1 is generated using the generated private key and the authentication information. AES (Advanced Encryption Standard) private key 2 is generated using RSA private key and AES private key 1.

AES private key 1 is used in encrypting the header portion of the security file. AES private key 2 is used in encrypting the body portion of the security file. At this time, the encryption can be carried out with RSA public key to protect the leakage of AES private key 1 and AES private key 3. This is for prevent the loss or change of the keys.

The cloud server manages keys to generate two prime numbers, which is equal process in mobile terminal, using the information (ID, password, equipment unique value, MAC, telephone number, etc.) transmitted when user performs authentication process.

In the cloud server (key management server), the period of changing password is set by the manager. For example, it is assumed that the period is one month. Once the password is changed, the authentication information becomes changed. The encrypted AES private keys 1, 2 are thus decrypted. Then, the new AES private keys 1, 2 are generated by using the changed authentication information. The security file is encrypted with newly generated AES private keys 1, 2. If the authentication information is disused, the generated keys are abolished.

The reason why AES keys are stored in the mobile terminal is to decrypt the security file with the AES keys, when the authentication information is changed. Generating RSA pair keys is for encrypting the stored keys.

According to this method, the keys exchange process like PKI can be removed as well as the exchange of certificate. It is effective in protecting the leakage against network sniffing or spoofing. The method can provide the solution about HeartBleed which becomes a hot issue in computer security.

Meanwhile, the security file is applicable to various kinds of OS. The security file can be generated without root admin privilege, called ‘rooting’. In accordance with this point, the security file can be installed with simple process.

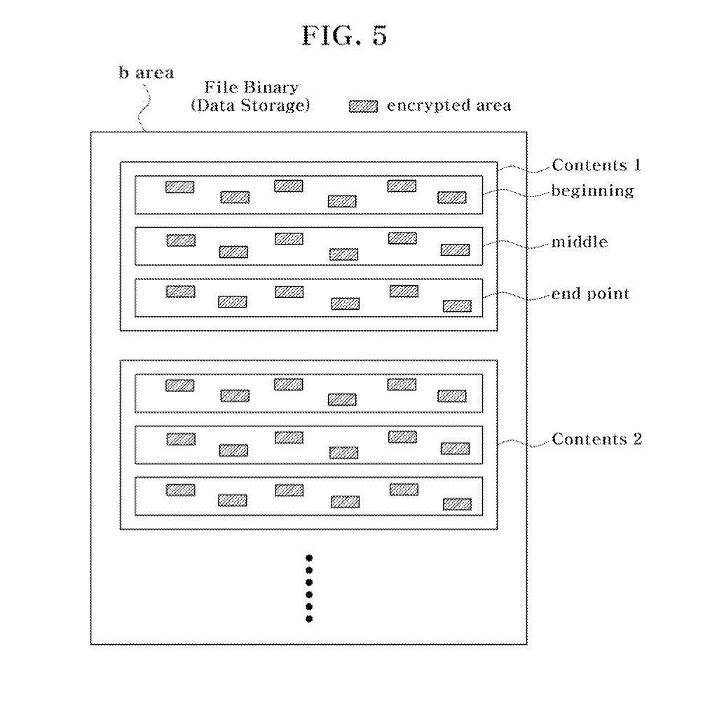

FIG. 5 is a flow chart showing a method of partially encrypting the security file according to the invention.

A content is included in the security file and the meta data related to the content is stored in the header area a. A File binary is divided into beginning, middle, and end. The partial encryption may be performed with 10% through 100% portion. Partial encryption is effective in improving the encryption/decryption speed. When the encryption is performed, body portion b is updated by the encrypted file binary.

Referring to FIG. 5, content 1 and content 2 has beginning, middle, and end, respectively. Each part is partially encrypted. Preferably, the partial encryption may be performed with 10% through 90% portion. As the encrypted portion gets smaller, the encryption speed gets increased and the security gets worse. As the encrypted portion gets larger, the encryption speed gets decreased and the security gets better. Considering this point, it is more preferable that the partial encryption may be performed with 30% through 70% portion.

In the partial encryption, the unencrypted portion of the file is exposed to vulnerability. To solve this issue, each file binary is shuffled with each other. The shuffle process is to improve the level of the security.

Thereafter, the shuffle method will be explained in detail.

To shuffle the file binaries in accordance with the invention, a unique S-BOX is needed. The S-Box in CBC (Cipher-block chaining) algorithm is changed into proper unique S-Box in accordance with the invention. The reason why the unique S-BOX is used is to hide encryption algorithm. If the algorithm is exposed, normal S-BOX can be decrypted. The unique S-Box is preferably changed to prevent the delay of the speed in encryption using CBC (Cipher-block chaining) algorithm.

This unique S-BOX is generated with the authentication information of terminal and server. If with the authentication information is changed, S-BOX is changed. Therefore, this unique S-BOX is different according to the terminal. This feature has an advantage. Even if one terminal is cracked, the other terminals cannot be cracked spontaneously. It can improve the security level of the system.

Referring to FIG. 5, the shuffle is performed with block unit. When the shuffle operation reaches to the end of content, content 2 is used in shuffle process. After the shuffle, buffer values are replaced using the unique S-BOX.

The inventors measured the speed of encryption & decryption process between the existing measure and the solution suggestion. The assessment is shown as the table 1. Table 1 shows the comparison of the speed in the encryption performances between the conventional measure and the solution suggestion (unit: ms).

TABLE 1

| | the existing | the solution | |
|---|---|---|---|
| | measure | suggestion | the time |
| classification | (Stream50%) | (Stream50%) | gap |
| 10EA | 12730 | 10388 | 2342 |
| | 17458 | 13147 | 4311 |
| | 16660 | 10613 | 6047 |
| 20EA | 31237 | 25641 | 5596 |
| | 38128 | 22637 | 15491 |
| | 40344 | 26514 | 13830 |
| 50EA | 89141 | 64759 | 24382 |
| | 88757 | 50583 | 38174 |
| | 91546 | 65135 | 26411 |

The inventors checked the speed of the encryption performances, using 10, 20 and 50 files under the same conditions. The existing measure set for key generation per a file, which is less efficient than the solution suggestion. As the more files are generated, the bigger differences are being made. When 50 different files are encoded at the same time, the maximum time gap between the exiting measure and solution suggestion was 38 second, which shows the speed of the encryption performances was improved.

Table 2 shows a comparison between the present invention and conventional method.

| Class | Prior Proposed Method | SiS Container |
|---|---|---|
| Encryption | If a parital encryption | Although a partial |
| | applied, plain text | encryption is applied, |
| | can be exposed; | due to a built-in shuf- |
| | | fling method, file content |
| | | is still obfuscated. |
| Latency | Moderate | Low |
| caused by | | |
| en/decryption | | |
| process | | |
| Support | Dedicated viewer is required; | Support multiple native |
| native apps | when decrypting a file. | viewers and no risks |
| | plain text (temp file) can | of temp file being |
| | be security risk | saved when viewing files |

If a content is deleted by the user, the meta data of the corresponding content in the header portion of the security file is removed and the body portion b in the file binary is deleted and updated. In this case, if the file binary is partially encrypted and be shuffled, the shuffled file binary is first restored and corresponding content is deleted.

If the name of the content is changed, only meta data of the header portion is renewed. In case of data change, only the file binary is newly changed.

If viewed, the logic structure in the header portion can be read for the listing without the decryption of the entire body portion. View operation is not the open operation. The list file header portion makes the file/folder to be listed faster.

Additional security policy is possible for improvement of the security file.

First, when a content, for example word file, is opened, the mobile application prohibits the copy operation by normal screen capture and clipboard

second, when a file sharing is operated in mobile terminal, the mobile application prevents a content file from saving as a different file name.

Third, when a file sharing is operated in mobile terminal, the mobile application prevents a content from sharing it by email or other online path.

To satisfy the first requirement, separate function is needed to prevent the Activity of screen capture and clipboard. The mobile OS such as Android and IOS provide a screen capture function. Hardware manufacturer provide the tools for the screen capture function as well.

In order to protect a content from various screen capture, the mobile application may activate ‘Activity’ that is transparent by running an extra service type of Application. In Android OS, the user registers an Activity related to window viewer and enlarge the Activity to the similar size of full display screen. In this method, when the user tries to capture the screen, the registered view image already registered through the present mobile application is captured and the view of the content, which needs to be protected, is not captured.

Capture Protection Code is depicted as the same in code 1.

private void f ( )
{

// Create TextView
tvTopWindow = new TextView(this);
// Setting argument of a view
LayoutParams params = new LayoutParams(LayoutParams, ....);
// Get WindowsManager
WindowManager wm =

(WindowManager)getSystemService(Context.WINDOW_SERVICE):

// Make enable Textview by using window manager
wm.addView(tvTopWindow. params);

}

In mobile terminal environment, the way the clipboard operates is that when a content is copied, the copied content is sent to clipboard manager. The manager then send the copied contents to application in the mobile terminal. If we use the data from the clipboard, we use the data that was broadcasted by the clipboard manager.

Thus, when we need to secure copied content in the clipboard, a following method is used. Once we get a broadcast from the clipboard manager, saying that there are texts inserted to the clipboard, the security file responses to the clipboard manager either with an empty buffer or an alert message. When we send data to the clipboard manager, we may send data for 3-7 times consecutively, because there are other smart devices that can store multiple clipboards. In an event an App uses data from the clipboard, we can see that the App receives the data from the security file instead of what was copied from the clipboard.

To cope with the second requirement, the observer needs to be installed to monitor and prevent a file being saved in either internal memory or external memory. When such a case occurs, the file will be deleted by the observer.

Finally, as for the third requirement, since the files (contents) are kept in the security file, no sharing can take place via email or online measures. Only way to access the file in the security file is via the security file's interface. No application can access the file in the security file whatsoever.

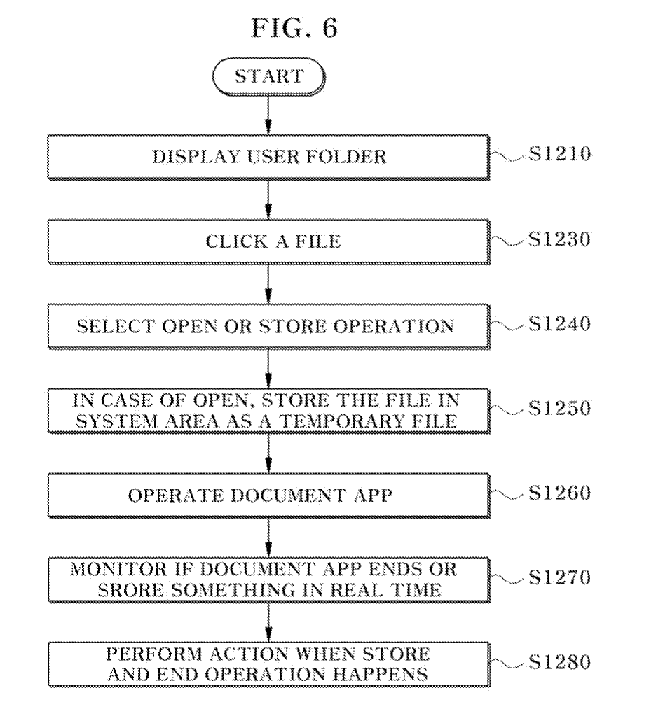

FIG. 6 is a flow chart illustrating a process of performing a file read operation using the mobile application 1100 shown in FIG. 2.

Referring to FIG. 6, after confirming the relevant folder, the user may select any files in the relevant folder. It is assumed in this embodiment that a document file (111.doc) is selected by the user (S1130). In this case, the mobile application 1110 may launch an event for selecting whether to open or store the relevant file (S1240).

First, in case where the user selects to open the relevant file, the mobile application 1100 stores a temporary file in an area “data/data/xxx.xxxx (Application File name) in Android OS, “xxx.xxxxprivate/var/mobile/Applications/ (Application File name)/Document” in IOS OS. The reason to save the temporary file in system area is intended to protect from hacking the temporary file that is not encrypted up to now.

Thereafter, the mobile application 1100 runs in cooperation with an application suitable for the format of the file to be opened (S1260). That is, when performing an open operation of the document file (111.doc), the mobile application 1100 runs in cooperation with a word processing application installed in the mobile terminal. The user can view the opened file using the word processing application.

In case where the type of the document file to be opened is a doc file, it may be implemented using the following codes:

if (File_extend.equals(“DOC”) ∥ File_extend.equals(“DOCX”)
intentset.DataAndType(Uri.fromFile(file), “application/msword”);

The commands such as File_extend.equals, intent.setDataAndType, and the like corresponds to a Java command, and a viewer compatible to the MS-WORD may be presented on a screen if the file has an extension of .doc or .docx.

Meanwhile, during the word processing application runs, the security module 1140 of the mobile application 1100 monitors in the real time whether the word processing application stores the file or finished working on the file (S1270). As a result of the monitoring, when the word processing application stores the file or finished working on the file, a necessary action may be taken (S1280).

Explaining by the way of example of the Android, the real time monitoring may be activated by “FileObserver” class of Android. For example, the following code is illustrated.

fileobserver(NotifyEvent, monitoring path)

After establishing setting as above, the Android operating system calls the OnEvent( ) function, which is so called a Callback.

OnEvent(NotifyEvent, changed file path)

Meanwhile, in case where working on the document is finished, the temporary file stored in the system area is deleted. If the word processing application tries to store the temporary file in another place, the mobile application 1100 blocks the storage in another place or remembers the stored file in other to delete it when the word processing application will be finished. In case where an opened file has been changed, the mobile application allows the opened file to be stored in the cloud server and update the file synchronization.

According to the invention, the contents stored in mobile terminal are easily accessible and can be effectively protected from other attack. Through the security file and the partial encryption, security performance can be improved.

while the embodiments of the present invention has been described and shown as set forth above, it will be understood by those skilled in the art that various changes and modifications may be made through addition, changes, the invention as defined in the following claims, and these are intended to be embraces by the scope of the claims of the present invention.

What is claimed is:

1. A security file for a plurality of contents, the security file includes:
a header portion for storing file names and folder structure of the plurality of contents; and
a body portion for storing file binary values of the plurality of contents,
wherein the file binary values of the plurality of contents is partially encrypted.

2. The security file according to claim 1,
wherein a respective of the file binary values of the plurality of contents includes beginning, middle, and end.

3. The security file according to claim 1,
wherein the file binary values of the plurality of contents is shuffled with each other.

4. A method for protecting a plurality of contents in mobile terminal, the method includes:
storing a header portion for storing file names and folder structure of the plurality of contents; and a body portion for storing file binary values of the plurality of contents, when the plurality of contents are stored;
wherein the file binary values of the plurality of contents is partially encrypted.

5. The method according to claim 4,
wherein a respective of the file binary values of the plurality of contents includes beginning, middle, and end.

6. The method according to claim 4,
wherein the file binary values of the plurality of contents is shuffled with each other.

7. A computer readable medium for the method according to claim 4.

8. A computer readable medium for the method according to claim 5.

9. A computer readable medium for the method according to claim 6.
